(19) United States
(12) Patent Application Publication
(10) Pub. No.: US 2012/0087282 A1
(43) Pub. Date: Apr. 12, 2012

(54) WIRELESS COMMUNICATION HIGH-FREQUENCY CIRCUIT AND WIRELESS COMMUNICATION APPARATUS

(75) Inventor: Teruhisa SHIBAHARA, Nagaokakyo-shi (JP)

(73) Assignee: MURATA MANUFACTURING CO., LTD., Nagaokakyo-shi (JP)

(21) Appl. No.: 13/329,673

(22) Filed: Dec. 19, 2011

Related U.S. Application Data
(63) Continuation of application No. PCT/JP2010/059061, filed on May 28, 2010.

(30) Foreign Application Priority Data
Jul. 2, 2009 (JP) 2009-157447

(51) Int. Cl. H04B 7/00; H01P 1/10

(52) U.S. Cl. 370/277; 333/101

(57) ABSTRACT

A wireless communication high-frequency circuit in which a broadband amplifier is shared between multiple communication frequency bands and multiple duplexers are used in order to support the multiple communication frequency bands to improve the transmission efficiency includes a first impedance matching circuit between an output port of an amplifier and a relay switch. A first signal path extends from the output port of the amplifier to the ground in the first impedance matching circuit. An inductor and a variable capacitance element are provided on the first signal path. Second impedance matching circuits are provided between output ports and the input port of the relay switch and transmission signal input ports of duplexers, respectively.

### BACKGROUND OF THE INVENTION

1. Field of the Invention

The present invention relates to a wireless communication high-frequency circuit using, for example, a mobile phone terminal and a wireless communication apparatus.

2. Description of the Related Art

Mobile phone terminals in recent years are generally capable of using multiple communication frequency bands. For example, Japanese Unexamined Patent Application Publication No. 2002-325049 discloses a communication terminal that uses both CDMA and TDMA and that is capable of handover between CDMA and TDMA.

FIG. 1 is a diagram showing the system configuration of the communication terminal disclosed in Japanese Unexamined Patent Application Publication No. 2002-325049. The communication terminal mainly includes an antenna duplexer unit 2, a modulator-demodulator unit 4, a power amplifier unit 3, a signal processing unit 5, and a control unit 6. The modulator-demodulator unit 4 includes a TDMA modulator, a TDMA demodulator, a CDMA modulator, and a CDMA demodulator. The power amplifier unit 3 amplifies outputs from the modulators in the modulator-demodulator unit 4 and supplies the results of the amplification to the antenna duplexer unit 2. The signal processing unit 5 is connected to the modulator-demodulator unit 4. The control unit controls the antenna duplexer unit 2, the modulator-demodulator unit 4, the power amplifier unit 3, and the signal processing unit 5. A signal received with an antenna 1 is supplied to the TDMA demodulator and the CDMA demodulator in the modulator-demodulator unit 4 through the antenna duplexer unit 2, and the outputs from the TDMA modulator and the CDMA modulator in the modulator-demodulator unit 4 are supplied to the antenna duplexer unit 2 through the power amplifier unit 3.

The power amplifier unit 3 includes two amplifiers 31 and 33 and two switches 32 and 34. The antenna duplexer unit 2 includes a duplexer composed of filters 23 and 29.

The circuitry of a transmission portion of a mobile phone terminal that performs simultaneous transmission and reception includes “amplifier→duplexer→antenna”, as described above. The arrows→denote the flows of transmission signals and indicate that the components are connected in this order.

When radio waves within multiple communication frequency bands are transmitted and received with one mobile phone, it is generally necessary to provide the amplifiers and the duplexers of a number corresponding to the number of the communication frequency bands used in the transmission and reception. However, since the antenna is shared between all the communication frequency bands, the circuitry includes “amplifiers→duplexers→relay switch→antenna.” The relay switch is used to select one duplexer from the multiple duplexers and connect the selected duplexer to the antenna.

Development of broadband amplifiers capable of amplifying transmission signals within multiple communication frequency bands is recently expanded and such broadband amplifiers are in practical use in which it is sufficient to provide only the duplexers of a number corresponding to the number of the communication frequency bands. Since it is sufficient to provide the amplifiers and the antennas of a number smaller than the number of the communication frequency bands (ultimately one amplifier and one antenna), the circuitry includes “amplifiers→relay switch→duplexers→relay switch→antennas.” The relay switch between the amplifiers and the duplexers is used to select one duplexer from the multiple duplexers and connect the selected duplexer to the corresponding amplifier.

All the components including the amplifiers, the duplexers, and the antennas are designed so as to have a standard characteristic impedance of 50Ω. This is also a rule for direct connection of the high-frequency components in a state in which impedance matching is achieved between the high-frequency components. In other words, the connection of these components allows the impedance matching to be achieved at 50Ω and the connected components function as a certain circuit.

However, when the broadband amplifier described above is used to realize the circuitry including amplifiers→relay switch→duplexers, it is not possible to sufficiently achieve the impedance matching between the amplifiers and the duplexers, as described below. As a result, signal reflection occurs to degrade the transmission efficiency.

Specifically, an output portion of the amplifier is an emitter or a collector of a bipolar transistor or a source or a drain of a field effect type transistor. In either case, since an end of a current output line serves as an output port of the amplifier, the output impedance of the amplifier is very low and is generally 10Ω or less. As described above, since the input impedance of the duplexer is equal to 50Ω, it is necessary to provide a matching circuit in the output portion of the amplifier to convert the characteristic impedance of the output portion of the amplifier into 50Ω.

However, it is practically difficult to compose a matching circuit that converts a low impedance of 10Ω or less into 50Ω within a broad frequency range across multiple communication frequency bands. Accordingly, the impedance matching is not sufficiently achieved to cause the signal reflection, thus degrading the transmission efficiency.

In addition, since the impedance matching is also affected by, for example, a parasitic capacitance of lines connecting the components, the impedance matching is often not achieved at just 50Ω and only the connection of the components does not achieve excellent impedance matching. Accordingly, an inductor and/or a capacitor are often provided in order to perform fine tuning of the impedance matching state.

A method of including a variable capacitance element in the matching circuit provided in the output portion of the amplifier and switching the capacitance of the variable capacitance element in response to change of the communication frequency band is also considered. Since the matching state can be changed for every communication frequency band with this method, it is possible to achieve excellent impedance matching to suppress the degrading of the transmission efficiency caused by the signal reflection.

This method will now be described with reference to FIG. 2, FIG. 3, and FIG. 4. In FIG. 2, FIG. 3, and FIG. 4, a signal path 502 is formed from an output portion of an amplifier 510 to the ground, and a signal branch point 503 is provided on the signal path 502. A signal path 505 is formed from the signal branch point 503 to a relay switch 540. A variable inductance portion 520 effectively operating as a variable inductor is provided between the amplifier 510 and the signal branch point 503. The variable inductance portion 520 has different configurations in FIG. 2, FIG. 3, and FIG. 4.

In all the examples in FIG. 2, FIG. 3, and FIG. 4, a variable capacitance element 531 is provided between the signal branch point 503 and the ground. A matching circuit including the variable inductance portion 520 and the variable capacitance element 531 adjusts the value of the variable capacitance for every communication frequency band to increase the impedance of the output portion of the amplifier 510, thus adjusting the impedance at the relay switch 540 to 50Ω.

In addition, a circuit in which an inductor 532 is connected in series to a variable capacitance element 533 is provided between the signal path 505 and the ground. The inductor 532 and the variable capacitance element 533 cause series resonance at the frequency of a harmonic wave (a second harmonic wave or a third harmonic wave) of a transmission signal output from the amplifier 510 and the impedance at that time is set to a very low value. This circuit causes the harmonic wave to be shunted to the ground to remove the harmonic wave, thereby reducing the distortion component of the transmission signal. The harmonic wave frequency of the transmission signal is varied in response to a change in the communication frequency band. The capacitance value of the variable capacitance element 533 is switched in response to the variation in the harmonic wave frequency of the transmission signal and a target harmonic wave is suppressed.

The matching circuits shown in FIG. 2, FIG. 3, and FIG. 4 have the following two major advantages, compared with a matching circuit that does not use a variable capacitance element. A first advantage is that it is possible to achieve excellent impedance matching because the capacitance value of the variable capacitance element is varied in response to a change in the communication frequency band to perform the impedance matching in accordance with the communication frequency band that is used. A second advantage is that it is possible to more effectively suppress the harmonic wave because the frequency of the harmonic wave to be suppressed can be changed in response to a change in the communication frequency band that is used.

However, the matching circuits shown in FIG. 2, FIG. 3, and FIG. 4 have the following major disadvantages.

In the configuration in FIG. 2, an inductor 521 is connected in series to a variable capacitance element 522 to compose the variable inductance portion 520. Since the variable inductance portion 520 is configured so that the inductance of the inductor 521 is effectively decreased with the capacitance of the variable capacitance element 522 in the above manner, it is necessary to use the inductor 521 having an inductance much higher than the effective inductance of the entire variable inductance portion 520. The internal resistance (equivalent series resistance) of an inductor is generally increased with the increasing inductance of the inductor. Accordingly, when the configuration in FIG. 2 is adopted, the resistance of the variable inductance portion 520 is increased with respect to the effective inductance of the variable inductance portion 520. As a result, the loss in the variable inductance portion 520 is increased to degrade the transmission efficiency.

In the configuration in FIG. 3, an inductor 523 is connected in parallel to a variable capacitance element 524 to compose the variable inductance portion 520. Accordingly, currents in opposite directions flow through the inductor 523 and the variable capacitance element 524 and the difference between the current flowing through the inductor 523 and the current flowing through the variable capacitance element 524 flows through the variable inductance portion 520. Consequently, very large currents flow through the inductor 523 and the variable capacitance element 524, compared with the current flowing through the variable inductance portion 520. As a result, large loss is caused by the internal resistances of the inductor 523 and the variable capacitance element 524. Consequently, the loss in the variable inductance portion 520 is increased also in the configuration in FIG. 3, thus degrading the transmission efficiency.

In the configuration in FIG. 4, the variable inductance portion 520 uses variable capacitance elements as switches to perform switching between inductors. The value of the variable capacitance is increased to make a “state close to ON” and the value of the variable capacitance is decreased to make a “state close to OFF.” A complete ON state can be made if the capacitance of the variable capacitance element is set to infinite and a complete OFF state can be made if the capacitance of the variable capacitance element is set to zero. However, it is not possible to make the complete ON state and the complete OFF state because only a limited capacitance is practically generated.

Since the finite capacitance is given in the “state close to ON”, problems similar to those in the configuration in FIG. 2 are caused. Specifically, it is necessary to use an inductor having an inductance higher than the effective inductance of the variable inductance portion 520 and, thus, the internal resistance of the inductor is increased. As a result, the loss in the variable inductance portion 520 is increased to degrade the transmission efficiency.

Since the capacitance in the “state close to OFF” is not decreased to zero, problems similar to those in the configuration in FIG. 3 are caused. Specifically, since currents in opposite directions flow through the path that should be in the OFF state, the internal current of the variable inductance portion 520 is increased. As a result, the loss in the variable inductance portion 520 is increased to degrade the transmission efficiency.

As described above, in the configurations in FIG. 2, FIG. 3, and FIG. 4 including the variable inductance portion 520, a large loss occurs in the variable inductance portion 520 to degrade the transmission efficiency. In addition, since the variable inductance portion 520 composes a resonance system including the inductor(s) and the capacitor(s) in all the configurations in FIG. 2, FIG. 3, and FIG. 4, the impedance largely depends on the frequency. Accordingly, it is difficult to keep excellent impedance matching across the entire frequency band even within the same communication band and, thus, the degradation in the transmission efficiency caused by the signal reflection is not so reduced.

As shown in FIG. 5, another configuration in which the relay switch 540 is used to switch between impedance matching circuits 561, 562, and 563 for every communication band can be considered. However, this configuration also has a large problem. Since the output portion of the amplifier 510 has a low impedance (current transmission system), directly connecting the output portion of the amplifier 510 to the relay switch 540 as in FIG. 5 causes a large current to flow through the relay switch 540. Since the matching circuit is used to perform conversion into a high-impedance system, that is, conversion into a voltage transmission system and, then, perform connection to the relay switch in FIG. 2, FIG. 3, and FIG. 4, the amount of current flowing through the relay switch 540 is relatively small. In contrast, a large current flows through the relay switch 540 in the configuration in FIG. 5. Since the relay switch 540 has a contact resistance, a large loss occurs when a large current flows through the relay switch 540. Accordingly, the loss at the contact resistance of the relay switch 540 is increased in the configuration in FIG. 5 and, thus, high transmission efficiency is not achieved.

As described above, when the broadband amplifier is used, it is sufficient to provide only the duplexers of a number corresponding to the number of the communication frequency bands and the antenna is shared in the communication within the multiple communication frequency bands. The characteristic impedance is designed so as to be equal to 50Ω in every communication frequency band. However, practically, it is possible to further improve the radiation efficiency of the antenna if the characteristic impedance can be changed for every communication frequency band.

Among antennas of various modes, the most basic mode is use of an electric wire (pole) having a length equivalent to ¼ of the wavelength. Since it is not possible to ensure the length of ¼ of the wavelength when the antenna is included in a mobile phone, an electric wire that is effectively shorter than ¼ of the wavelength is used and an inductor is added to a base portion of the electric wire in order to compensate the shortage of length. When the same electric wire is shared between multiple communication frequency bands, it is desirable that the inductance of the inductor to be added to the base of the electric wire be changed for every communication frequency band. This is because, since the wavelength is decreased with the increasing frequency, the antenna provides higher impedance at higher frequency even with the same inductance, in addition to effective reduction in impedance by an amount corresponding to the shortage of the length of the electric wire.

Accordingly, when a short electric wire is used as an antenna, it is possible to further improve the radiation efficiency of the antenna if the characteristic impedance of a connection destination is changed for every communication frequency band and the inductance is set to a higher value with the decreasing frequency.

### SUMMARY OF THE INVENTION

Preferred embodiments of the present invention provide a wireless communication high-frequency circuit capable of resolving problems occurring in a circuit in which a broadband amplifier is shared between multiple communication frequency bands and multiple duplexers are used in order to support the multiple communication frequency bands to improve the transmission efficiency.

According to a preferred embodiment of the present invention, a wireless communication high-frequency circuit includes an amplifier that outputs transmission signals within a plurality of communication frequency bands; a first relay switch including a input port and a plurality of individual output ports; a first impedance matching circuit provided between an output port of the amplifier and the input port of the relay switch; a plurality of duplexers that include a transmission signal input port, a reception signal output port, and an input-output common port and that are provided for different communication frequency bands; and second impedance matching circuits connected between the first relay switch and the respective transmission signal input ports of the duplexers.

With the above configuration, the impedance matching between the amplifier and the duplexers is improved and the loss is reduced to improve the transmission efficiency.

The first impedance matching circuit includes, for example, a first signal path connecting the output port of the amplifier to the ground and a second signal path extending from a signal branch point, which is a halfway point on the first signal path, to the input port of the first relay switch. On the first signal path, a first reactance element (e.g., an inductor or a capacitor) is provided between the amplifier and the signal branch point and a second reactance element (e.g., a capacitor or an inductor) having a polarity opposite to that of the first reactance element is provided between the signal branch point and the ground. The “reactance elements having opposite polarities” indicates reactance elements the impedance imaginary portions of which have opposite signs. The reactance element having an opposite polarity with respect to a capacitor is an inductor, and the reactance element having an opposite polarity with respect to an inductor is a capacitor.

For example, the second reactance element is a variable capacitance element and no variable capacitance element is provided between the amplifier and the signal branch point on the first signal path, or the first reactance element is a variable capacitance element and no variable capacitance element is provided between the signal branch point and the ground on the first signal path.

With the above configuration, the capacitance value of the variable capacitance element can be varied for every communication frequency band to perform impedance conversion into higher impedance for every communication frequency. In addition, since no variable capacitance element is provided between the amplifier and the signal branch point on the first signal path, it is possible to avoid various problems including a disadvantage of an increase in the insertion loss, an increase in the loss caused by an increase in the internal current, and an occurrence of the signal reflection because an inductor and a variable capacitance define a resonance system to sharpen the frequency characteristic of the impedance.

For example, the variable capacitance element preferably is an electrostatically driven MEMS variable capacitance element, the first relay switch preferably is an electrostatically driven MEMS switch, and the electrostatically driven MEMS variable capacitance element and the first relay switch are preferably driven by a common drive IC.

Since high voltage is required in order to drive the electrostatically driven MEMS variable capacitance element and the electrostatically driven MEMS switch, a drive IC that generates high voltage to drive these elements is often separately required. When the electrostatically driven MEMS variable capacitance element and the electrostatically driven MEMS switch are used, one drive IC can be shared to reduce the cost and the size.

For example, the second impedance matching circuit preferably includes an adjustable reactance circuit and a variation in capacitance of the variable capacitance element is compensated by the adjustable reactance circuit.

With the above configuration, the variable capacitance element allowing a variation in capacitance to some extent can be used to facilitate the practical realization and substantially increase the manufacturing yield of the variable capacitance element, thus offering cost savings.

The adjustable reactance circuit preferably uses, for example, the inductance of a wire manufactured by wire bonding.

The adjustable reactance circuit preferably includes, for example, a capacitor, the capacitance of which is adjustable with laser light.

According to another preferred embodiment of the present invention, a wireless communication high-frequency circuit includes a plurality of duplexers that include a transmission signal input port, a reception signal output port, and an input-output common port and that are provided for different communication frequency bands; a second relay switch including an input port connected to an antenna and a plurality of individual input ports; and third impedance matching circuits provided between the respective input-output common ports of the plurality of duplexers and the second relay switch.

With the above configuration, the wireless communication high-frequency circuit is designed so that the impedance when the second relay switch side is viewed from the antenna is varied depending on which duplexer the path to which a contact of the second relay switch is connected leads to (that is, the antenna impedance is appropriately changed for every communication frequency band). Consequently, the radiation efficiency of the antenna in each communication band is improved.

For example, inductive impedance when the second relay switch side is viewed from the antenna is preferably set so as to be increased with the decreasing communication frequency band of the duplexer to which the contact of the second relay switch is connected.

In particular, in the case of an antenna whose prototype is an antenna resulting from reduction in size of a ¼-wavelength electric wire, a desired advantage is achieved by increasing the inductive impedance when the second relay switch side is viewed from the antenna with the decreasing communication band frequency of the duplexer to which the contact of the second relay switch is connected.

A further preferred embodiment of the present invention provides a wireless communication high-frequency circuit including an amplifier that outputs transmission signals within a plurality of communication frequency bands; a first relay switch including an input port and a plurality of individual output ports; a first impedance matching circuit provided between an output port of the amplifier and the input port of the relay switch; a plurality of duplexers provided for different communication frequency bands; second impedance matching circuits connected between the first relay switch and the respective duplexers; a second relay switch including a an input port connected to an antenna and a plurality of individual input ports; and third impedance matching circuits provided between the respective plurality of duplexers and the second relay switch.

With the above configuration, both of the advantages described with respect to the above preferred embodiments are achieved. In addition, since the separate matching circuits are provided on both sides of the duplexers, it is not necessary to set the characteristic impedance of the duplexers to 50Ω.

For example, inductive impedance when the second relay switch side is viewed from the antenna is preferably set so as to be increased with the decreasing communication frequency band of the duplexer to which the contact of the second relay switch is connected.

For example, the characteristic impedance of a port of at least one duplexer, among the plurality of duplexers, is preferably designed so as to be higher than about 50Ω.

The duplexers including elastic wave filters are generally reduced in size and cost with the increasing characteristic impedance (the number of chips cut out from a wafer is increased). Accordingly, it is possible to reduce the size and the cost of the entire wireless communication high-frequency circuit by designing the duplexers so that the characteristic impedances of the duplexers have values higher than about 50Ω in this configuration.

For example, the first relay switch and the second relay switch preferably are electrostatically driven MEMS switches, and the first relay switch and the second relay switch are preferably driven by a common drive IC.

Another preferred embodiment of the present invention provides a wireless communication apparatus including the wireless communication high-frequency circuit having any of the above configurations; a transmission circuit that supplies a transmission signal to the amplifier; and a reception circuit that receives a reception signal output from the duplexers.

According to various preferred embodiments of the present invention, the impedance matching between the amplifier and the duplexers is improved and the loss is reduced to improve the transmission efficiency.

In addition, the wireless communication high-frequency circuit is preferably designed so that the impedance when the second relay switch is viewed from the antenna is varied depending on which duplexer the path to which the contact of the second relay switch is connected leads to (that is, the antenna impedance is appropriately changed for every communication frequency band). Consequently, the radiation efficiency of the antenna in each communication band is improved.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram showing the system configuration of a communication terminal disclosed in Japanese Unexamined Patent Application Publication No. 2002-325049.

FIG. 2 is a diagram showing an example in related art in which an impedance matching circuit is provided between an amplifier and a relay switch in a configuration of the amplifier→the relay switch→duplexers.

FIG. 3 is a diagram showing another example in the related art in which an impedance matching circuit is provided between the amplifier and the relay switch in the configuration of the amplifier→the relay switch→the duplexers.

FIG. 4 is a diagram showing another example in the related art in which an impedance matching circuit is provided between the amplifier and the relay switch in the configuration of the amplifier→the relay switch→the duplexers.

FIG. 5 is a diagram showing another example in the related art in which impedance matching circuits are provided between the relay switch and the duplexers in the configuration of the amplifier→the relay switch→the duplexers.

FIG. 6 is a diagram showing the configuration of an up-stream wireless communication high-frequency circuit 100 according to a first preferred embodiment of the present invention.

FIG. 7 is a diagram showing the configuration of a down-stream wireless communication high-frequency circuit 200 according to a second preferred embodiment of the present invention.

FIG. 8 is a diagram showing the configuration of a wireless communication high-frequency circuit 300 according to a third preferred embodiment of the present invention.

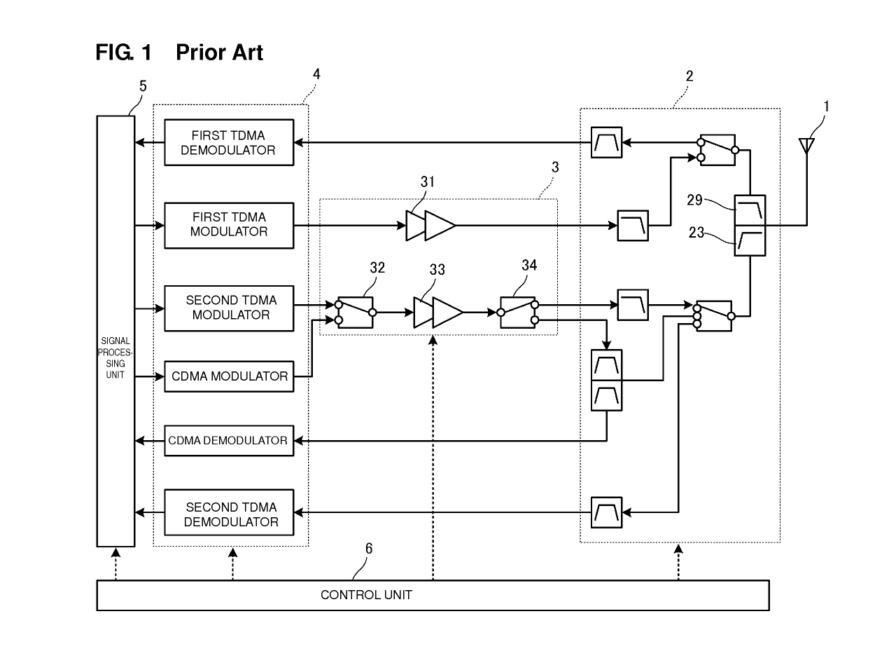

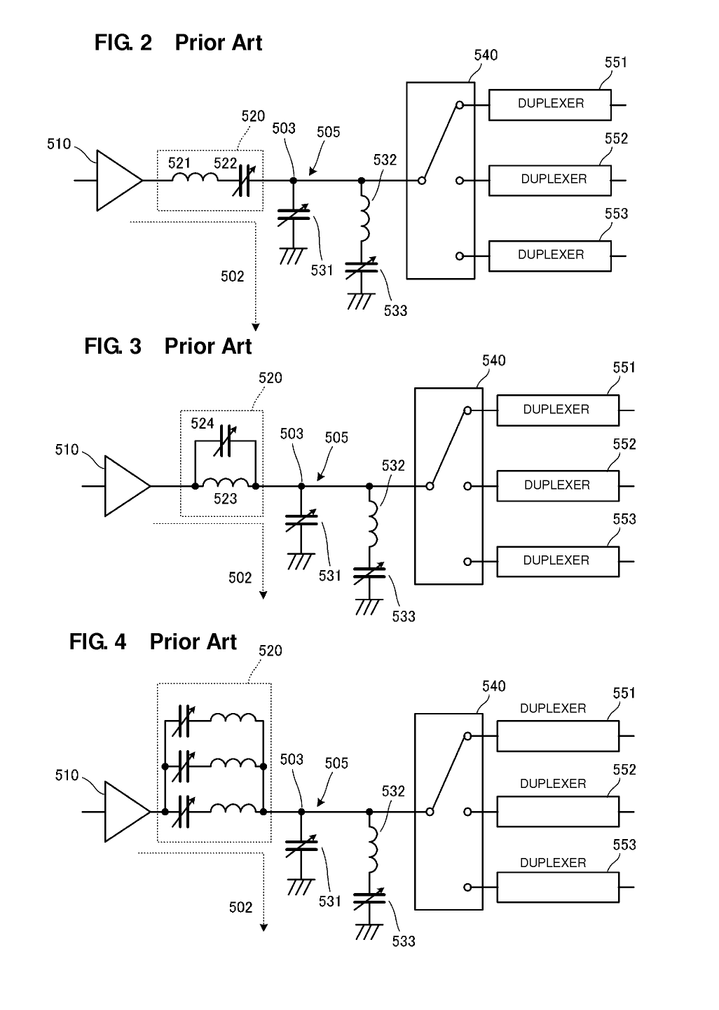

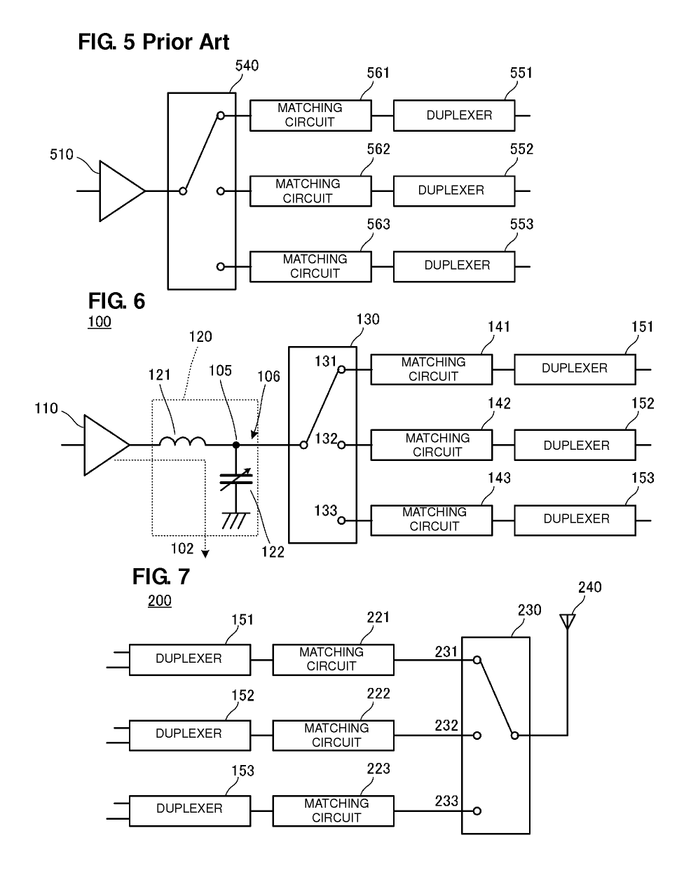

### DETAILED DESCRIPTION OF THE PREFERRED EMBODIMENTS

### First Preferred Embodiment

FIG. 6 is a diagram showing the configuration of an up-stream wireless communication high-frequency circuit 100 according to a first preferred embodiment of the present invention. A first impedance matching circuit 120 is provided between an output port of an amplifier 110 and a relay switch 130. A first signal path 102 denoted by a broken line in FIG. 6 extends from the output port of the amplifier 110 to the ground in the first impedance matching circuit 120. An inductor 121 and a variable capacitance element 122 are provided on the first signal path 102. A second signal path 106 extends between a signal branch point 105, which is a halfway point on the first signal path 102, and the relay switch 130.

The first impedance matching circuit 120 includes only the inductor 121 between the amplifier 110 and the signal branch point 105 on the first signal path 102 and does not include a variable capacitance element. This avoids various problems occurring when a variable inductor is provided. The various problems include a disadvantage of an increase in the insertion loss, an increase in the loss caused by an increase in the internal current, and an occurrence of the signal reflection because an inductor and a variable capacitance defines a resonance system to sharpen the frequency characteristic of the impedance.

Second impedance matching circuits 141, 142, and 143 are provided between output ports 131, 132, and 133 of the relay switch 130 and transmission-signal input ports of duplexers 151, 152, and 153, respectively.

The duplexers 151, 152, and 153 support the frequency bands of Universal Mobile Telecommunications System (UMTS) band 1, UMTS band 2, and UMTS band 3, respectively. The center frequencies of transmission signals within the UMTS band 1, the UMTS band 2, and the UMTS band 3 are 1,950 MHz, 1,880 MHz, and 1,752 MHz, respectively.

The first impedance matching circuit 120 is preferably designed so that the characteristic impedance of the output port of the amplifier 110 is matched with that of an input port of the relay switch 130. Specifically, a low impedance of the output port of the amplifier 110 is increased to the impedance (the standard value of 50Ω) of the input port of the relay switch 130.

The inductor 121 preferably has an element value of about 2 nH and the capacitance value of the variable capacitance element 122 is changed in response to switching of the communication band that is used. Specifically, the capacitance value of the variable capacitance element 122 is preferably set to about 3.3 pF in the UMTS band 1, about 3.6 pF in the UMTS band 2, and about 4.1 pF in the UMTS band 3.

The second impedance matching circuits 141, 142, and 143 are designed so that the impedances of the output ports 131, 132, and 133 of the relay switch 130 are matched with the characteristic impedance of about 50Ω of the duplexers 151, 152, and 153, respectively. For example, if the characteristic impedance of the output port 131 of the relay switch 130 is equal to about 30Ω in the frequency band of the UMTS band 1, the second impedance matching circuit 141 converts about 30Ω into about 50Ω. For example, if the characteristic impedance of the output port 133 of the relay switch 130 is equal to about 70Ω in the frequency band of the UMTS band 3, the second impedance matching circuit 143 converts about 70Ω into about 50Ω. For example, if the characteristic impedance of the output port 132 of the relay switch 130 is equal to about 50Ω in the frequency band of the UMTS band 2, the second impedance matching circuit 142 does not perform the impedance conversion.

The second impedance matching circuits 141, 142, and 143 each include an adjustable reactance circuit. This adjustable reactance circuit compensates for a variation in the capacitance of the variable capacitance element 122.

The adjustable reactance circuit preferably includes an inductor. The inductance of, for example, a wire used in wire bonding is used as the inductor. In other words, the bonding wire defines the inductor. The inductance of the inductor is adjusted in accordance with the length of the wire, that is, the bonding position.

The adjustable reactance circuit also includes a capacitor. The capacitance of the capacitor is adjusted by trimming with laser light.

The second impedance matching circuits 141, 142, and 143 perform the impedance matching between the relay switch 130 and the duplexers 151, 152, and 153, respectively, in the above manner.

With the above configuration, the impedance matching is achieved between the amplifier 110 and the duplexers 151, 152, and 153 to suppress the signal reflection, thereby maximizing the transmission efficiency. In addition, the second impedance matching circuits 141, 142, and 143 each include a harmonic suppression circuit. These harmonic suppression circuits suppress the harmonic waves having frequencies corresponding to the respective frequency bands.

For example, a series circuit including an inductor and a variable capacitance element is shunted between the signal path and the ground. The capacitance of the variable capacitance element is set so that the resonant frequency of the inductor and the variable capacitance element coincides with the frequency of a harmonic wave (a second harmonic wave or a third harmonic wave) of a transmission signal output from the amplifier 110. As a result, the harmonic wave leaks into the ground to be removed, thus reducing the distortion component of the transmission signal. Since the harmonic wave frequency of the transmission signal is also varied in response to a change in the communication frequency band, the capacitance of the variable capacitance element is switched in response to the variation in the harmonic wave frequency of the transmission signal to perform adjustment so that a target harmonic wave is suppressed.

The position of the inductor 121 in the circuit may be exchanged with that of the variable capacitance element 122 in the circuit. Specifically, the variable capacitance element may be provided between the amplifier 110 and the signal branch point 105 and the inductor may be provided between the signal branch point 105 and the ground. However, the circuit constants of the second impedance matching circuits 141, 142, and 143 are slightly varied in that case.

Also in this case, it is sufficient to provide the inductor between the signal branch point 105 and the ground and a variable capacitance element is not provided therebetween. This avoids various problems occurring when a variable inductor is provided. The various problems include a disadvantage of an increase in the insertion loss, an increase in the loss caused by an increase in the internal current, and an occurrence of the signal reflection because an inductor and a variable capacitance defines a resonance system to sharpen the frequency characteristic of the impedance.

In addition, an electrostatically driven MEMS variable capacitance element may preferably be used as the variable capacitance element 122 and an electrostatically driven MEMS switch may be used as the relay switch 130.

A configuration in which an electrostatically driven MEMS variable capacitance element is preferably used as the variable capacitance element 122, an electrostatically driven MEMS switch is preferably used as the relay switch 130, and the electrostatically driven MEMS variable capacitance element and the electrostatically driven MEMS switch are preferably driven by one drive integrated circuit (IC) may be adopted. In this case, the drive IC is shared to reduce the cost and the size.

### Second Preferred Embodiment

FIG. 7 is a diagram showing the configuration of a down-stream wireless communication high-frequency circuit 200 according to a second preferred embodiment of the present invention. A port of an antenna 240 is connected to an output port of a second relay switch 230, and multiple input ports 231, 232, and 233 of the second relay switch 230 are connected to input-output common ports of the duplexers 151, 152, and 153 via third impedance matching circuits 221, 222, and 223, respectively. The impedance when the second relay switch 230 side is viewed from the antenna 240 is varied depending on which duplexer the port to which the contact of the second relay switch 230 is connected leads to. The inductance is increased with the decreasing input-output frequency band of the duplexer to which the port to which the contact of the second relay switch 230 is connected leads.

Either of the third impedance matching circuits 221, 222, and 223 is connected to a base of the antenna 240 depending on the communication frequency band to change the antenna impedance viewed from the corresponding duplexers 151, 152, and 153. In other words, when a short electric wire is used as the antenna, the switching is performed so that the inductance of the third impedance matching circuit is increased with the decreasing frequencies of the communication frequency band.

As a result, the antenna impedance is appropriately changed for every communication frequency band to improve the radiation efficiency of the antenna within each communication band.

### Third Preferred Embodiment

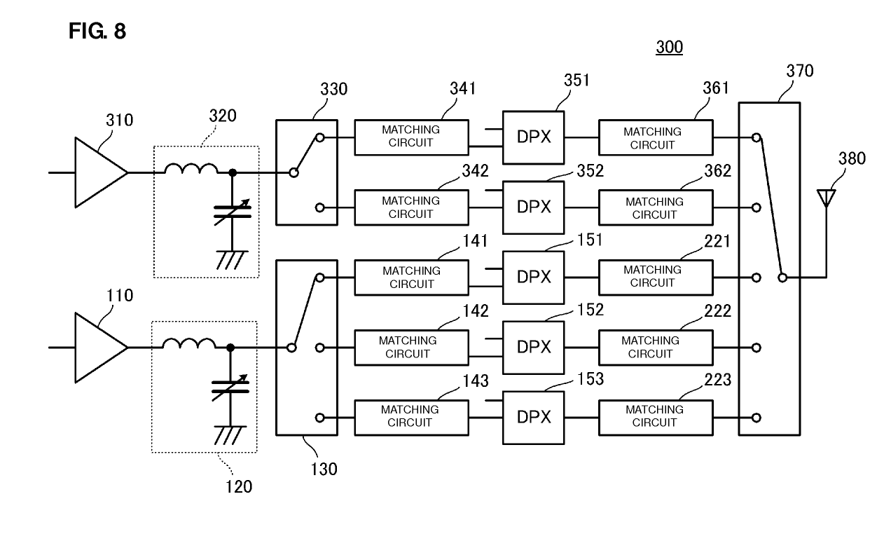

FIG. 8 is a diagram showing the configuration of a wireless communication high-frequency circuit 300 according to a third preferred embodiment of the present invention. This wireless communication high-frequency circuit 300 is a circuit including amplifiers that perform power amplification of a transmission signal to an antenna. The wireless communication high-frequency circuit 300 includes five duplexers 151, 152, 153, 351, and 352. Among these duplexers, the duplexers 151, 152, and 153 support the frequency range of the UMTS band 1, the UMTS band 2, and the UMTS band 3, respectively, and the duplexers 351 and 352 support the frequency range of UMTS band 5 and UMTS band 8, respectively.

The amplifier 110 performs the power amplification to the transmission signal at a certain gain across the frequency range of the UMTS band 1 to the UMTS band 3. An amplifier 310 performs the power amplification to the transmission signal at a certain gain across the frequency range of the UMTS band 5 and the UMTS band 8. A first impedance matching circuit 320 is provided between an output port of an amplifier 310 and a relay switch 330.

An antenna 380 supports all the frequency ranges.

In the circuit shown in FIG. 8, the configuration of the amplifier 110, the first impedance matching circuit 120, the relay switch 130, the second impedance matching circuits 141, 142, and 143, the duplexers 151, 152, and 153, and the third impedance matching circuits 221, 222, and 223 is the same as the one shown in the first and second preferred embodiments.

In the wireless communication high-frequency circuit 300, the amplifiers 110 and 310 support the two frequency ranges, and the first impedance matching circuit 120 is provided for the amplifier 110 and a first impedance matching circuit 320 is provided for the amplifier 310. The second impedance matching circuit 141, 142, 143, 341, and 342 are provided for the duplexers 151, 152, 153, 351, and 352, respectively. In addition, the third impedance matching circuits 221, 222, 223, 361, and 362 are provided for the duplexers 151, 152, 153, 351, and 352, respectively.

A relay switch 370 is provided to switch between the second impedance matching circuits, the duplexers, and the third impedance matching circuits in accordance with the frequency band that is used, among the frequency bands described above.

The amplifiers of a small number are preferably used, the antenna is shared, and an optimal duplexer is used for each frequency band in the above manner to compose the wireless communication high-frequency circuit 300 processing the multiple frequency bands.

Since the second impedance matching circuits 141, 142, 143, 341, and 342 are connected to transmission signal input ports of the duplexers 151, 152, 153, 351, and 352 and the third impedance matching circuits 221, 222, 223, 361, and 362 are connected to common ports thereof, the characteristic impedances of the transmission signal input ports and the common ports of the duplexers 151, 152, 153, 351, and 352 are not necessarily equal to the standard value of 50Ω. In other words, even when the characteristic impedance of the duplexers is not equal to 50Ω, the second impedance matching circuits and the third impedance matching circuits can achieve the impedance matching in accordance with the characteristic impedance of the duplexers.

The duplexers may include elastic wave filters. In general, the elastic wave filters are reduced in size and the number of chips cut out from a wafer is increased with the increasing characteristic impedance that is designed, whereby reducing the cost of the elastic wave filters. Accordingly, it is possible to reduce the size and the cost of the entire wireless communication high-frequency circuit by designing the duplexers 151, 152, 153, 351, and 352 so that the characteristic impedances thereof are equal to the impedance (a value higher than 50Ω) of input-output ports of the elastic wave filters.

A transmission circuit is connected to inputs ports of the amplifiers 110 and 310 in the wireless communication high-frequency circuit 300 and a reception circuit is connected to reception-signal output ports of the duplexers 151, 152, 153, 351, and 352 in the wireless communication high-frequency circuit 300, thereby defining a wireless communication apparatus.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A wireless communication high-frequency circuit comprising:
an amplifier that outputs transmission signals within a plurality of communication frequency bands;
a first relay switch including an input port and a plurality of individual output ports;
a first impedance matching circuit provided between an output port of the amplifier and the input port of the relay switch;
a plurality of duplexers that include a transmission signal input port, a reception signal output port, and an input-output common port and that are provided for different communication frequency bands; and
second impedance matching circuits connected between the first relay switch and the respective transmission signal input ports of the duplexers.

2. The wireless communication high-frequency circuit according to claim 1, wherein the first impedance matching circuit includes a first signal path connecting the output port of the amplifier to a ground and a second signal path extending from a signal branch point, which is a halfway point on the first signal path, to the input port of the first relay switch, and
on the first signal path, a first reactance element is provided between the amplifier and the signal branch point and a second reactance element having a polarity opposite to that of the first reactance element is provided between the signal branch point and the ground.

3. The wireless communication high-frequency circuit according to claim 2, wherein the second reactance element is a variable capacitance element and no variable capacitance element is provided between the amplifier and the signal branch point on the first signal path, or the first reactance element is a variable capacitance element and no variable capacitance element is provided between the signal branch point and the ground on the first signal path.

4. The wireless communication high-frequency circuit according to claim 3, wherein the variable capacitance element is an electrostatically driven MEMS variable capacitance element, the first relay switch is an electrostatically driven MEMS switch, and the electrostatically driven MEMS variable capacitance element and the first relay switch are driven by a common drive IC.

5. The wireless communication high-frequency circuit according to claim 3, wherein the second impedance matching circuit includes an adjustable reactance circuit and a variation in capacitance of the variable capacitance element is compensated by the adjustable reactance circuit.

6. The wireless communication high-frequency circuit according to claim 5, wherein the adjustable reactance circuit uses an inductance of a wire manufactured by wire bonding.

7. The wireless communication high-frequency circuit according to claim 5, wherein the adjustable reactance circuit is a capacitor, a capacitance of which is adjustable with laser light.

8. A wireless communication high-frequency circuit comprising:
a plurality of duplexers that include a transmission signal input port, a reception signal output port, and an input-output common port and that are provided for different communication frequency bands;
a relay switch including a common input port connected to an antenna and individual input ports; and
impedance matching circuits provided between the respective input-output common ports of the plurality of duplexers and the relay switch.

9. The wireless communication high-frequency circuit according to claim 8, wherein inductive impedance when the relay switch side is viewed from the antenna is arranged to be increased with a decreasing communication frequency band of the duplexer to which a contact of the relay switch is connected.

10. A wireless communication high-frequency circuit comprising:
an amplifier that outputs transmission signals within a plurality of communication frequency bands;
a first relay switch including an input port and a plurality of individual output ports;
a first impedance matching circuit provided between an output port of the amplifier and the input port of the relay switch;
a plurality of duplexers provided for different communication frequency bands;
second impedance matching circuits connected between the first relay switch and the respective duplexers;
a second relay switch including a common input port connected to an antenna and individual input ports; and
third impedance matching circuits provided between the respective plurality of duplexers and the second relay switch.

11. The wireless communication high-frequency circuit according to claim 10, wherein inductive impedance when the second relay switch side is viewed from the antenna is arranged to be increased with the decreasing communication frequency band of the duplexer to which a contact of the second relay switch is connected.

12. The wireless communication high-frequency circuit according to claim 10, wherein a characteristic impedance of a port of at least one duplexer, among the plurality of duplexers, is higher than about 50Ω.

13. The wireless communication high-frequency circuit according to claim 10, wherein the first relay switch and the second relay switch are electrostatically driven MEMS switches, and the first relay switch and the second relay switch are driven by a common drive IC.

14. A wireless communication apparatus comprising:
the wireless communication high-frequency circuit according to claim 1;
a transmission circuit that supplies a transmission signal to the amplifier; and
a reception circuit that receives a reception signal output from the duplexers.
